(19) United States
(12) Patent Application Publication
(10) Pub. No.: US 2022/0285771 A1
(43) Pub. Date: Sep. 8, 2022

(54) ARRANGEMENT OF TRACTION BATTERY CELLS FOR ELECTRIC VEHICLE AND BATTERY PACK

(71) Applicant: TSINGHUA UNIVERSITY, Beijing (CN)

(72) Inventors: QING ZHOU, Beijing (CN); PO-WEN CHEN, Beijing (CN); YONG XIA, Beijing (CN)

(21) Appl. No.: 17/536,082

(22) Filed: Nov. 28, 2021

(30) Foreign Application Priority Data
Mar. 8, 2021 (CN) 202110249553.0

(51) Int. Cl. H01M 50/209; H01M 50/249

(52) U.S. Cl. CPC H01M 50/209; H01M 50/249; H01M 2220/20

(57) ABSTRACT

An arrangement of battery cells in a battery pack for an electric vehicle is provided. In the arrangement of battery cells, the battery cells are fixed in a housing of the battery pack and inclined with respect to a bottom face and/or a lateral face of the housing of the battery pack.

### CROSS-REFERENCE TO RELATED APPLICATIONS

This application claims priority of China Patent Application No. 202110249553.0, filed on Mar. 8, 2021, entitled “ARRANGEMENT METHOD OF TRACTION BATTERY CELLS FOR ELECTRIC VEHICLE AND BATTERY PACK”, the content of which is hereby incorporated by reference in its entirety.

### TECHNICAL FIELD

The present disclosure relates to the technical field of traction battery of electric vehicle, in particular to an arrangement of battery cells of a traction battery for an electric vehicle and a battery pack.

### BACKGROUND

The electric vehicle battery (EVB) is used to supply power to the electric motor of the battery electric vehicle (BEV) or the hybrid electric vehicle (HEV). Nowadays, the electric vehicle battery is mainly the lithium-ion battery, which is generally positioned at the bottom of the electric vehicle and integrated onto the floor panel of the vehicle body. In order to satisfy the demand for a longer driving range of the electric vehicle, the volume of the battery pack is increased to contain more battery cells, so that more power can be continuously supplied to the electric motor. However, in that case, the floor panel of the vehicle body is usually lowered, so as to provide more space for the larger battery pack while not to reduce the inner space of the electric vehicle and not to increase the overall height of the electric vehicle. That is, the increased volume of the battery pack generally reduces the distance from the floor panel of the vehicle body to the ground. As a result, the bottom of the electric vehicle is easy to collide with an object such as a stone on the road in driving of the vehicle, and the impact on the vehicle bottom may severely damage the electric vehicle battery, and even cause the thermal runaway and spontaneous explosion of the electric vehicle battery.

At present, a main method for solving the above issue caused by the bottom collision accident of the electric vehicle is to modify the structure of the floor panel, for example, by adding a protection plate, to improve the impact resistance of the floor panel and reduce the damage to the electric vehicle battery in the bottom collision accident. However, such a method involves the reconfiguration of the entire floor panel of the electric vehicle, increases the manufacture cost and the overall weight of the electrical vehicle, and thus is detrimental to the increase of the driving range of the electrical vehicle.

### SUMMARY

An arrangement of battery cells in a battery pack for an electric vehicle is provided. In the arrangement of battery cells, the battery cells are fixed in a housing of the battery pack and inclined with respect to a bottom face and/or a lateral face of the housing of the battery pack.

In an embodiment, the battery cells are inclined toward a vehicle head side of the electric vehicle.

In an embodiment, the battery cells are inclined toward a vehicle tile side of the electric vehicle.

In an embodiment, an angle between the battery cells and the bottom face and/or the lateral face of the housing of the battery pack is larger than or equal to 45° and smaller than 90°.

In an embodiment, an inclination gap is defined between a bottom face of the battery cell and the bottom face of the housing of the battery pack, and a support is disposed in the inclination gap.

In an embodiment, the support is made of a compression-resistant buffer material.

In an embodiment, all of the battery cells in the battery pack are inclined in the same direction.

In an embodiment, all of the battery cells in the battery pack are positioned in parallel with each other.

In an embodiment, a deformation accommodating gap is formed between any two adjacent battery cells.

In an embodiment, a number of the battery cells adjacent to a vehicle head side of the electric vehicle are inclined toward the vehicle head side of the electric vehicle, and a number of the battery cells adjacent to a vehicle tile side of the electrical vehicle are inclined toward the vehicle tile side of the electric vehicle.

A battery pack for an electric vehicle is further provided. The battery pack includes a housing and battery cells. The battery cells are arranged in the housing by the above-described arrangement manner.

In the present disclosure, the battery cells are fixed in the housing of the battery pack in an inclined arrangement manner. As compared to the battery pack in the related art with battery cells in the vertical arrangement, the structures and the sizes of the housing and the battery cells can be the same, but the battery cells are inclined with respect to the bottom face and/or the lateral face of the housing of the battery pack. In this way, when the bottom collision accident occur, since the battery cells are previously arranged in the inclined state, the impact energy absorbed by the battery cells can be effectively decreased, while the impact energy absorbed by the housing of the battery pack is increased, so that the bending deformations of the battery cells can be effectively alleviated, and the concentrated deformation amount for the battery cells can be reduced. Therefore, the deformation of the battery cells can be confined within the deformation limit thereof, thus avoiding the short circuit and the thermal runaway of the battery cells. Thus, the damage to the battery cells in the bottom collision accident can be decreased by modifying the arrangement of the battery cells without changing the battery pack, the battery cells, and the floor panel of the electric vehicle, i.e., without increasing the cost and overall weight of the electric vehicle, thereby improving the safety and the reliability of the battery pack in the bottom collision accident.

### BRIEF DESCRIPTION OF THE DRAWINGS

FIG. 1 is a schematic structural view of a battery pack in an electric vehicle in related art.

FIG. 2 is a partially enlarged view, showing an arrangement of battery cells in a housing of the battery pack in FIG. 1.

FIG. 3 is a schematic structural view of a battery pack according to an embodiment of the present disclosure.

FIG. 4 is a partially enlarged view, showing an arrangement of battery cells in a housing of the battery pack in FIG. 3.

FIG. 5 is a schematic structural view of a battery pack according to another embodiment of the present disclosure.

FIG. 6 is a partially enlarged view, showing an arrangement of battery cells in a housing of the battery pack in FIG. 5.

FIG. 7 is a graph showing curves of total plastic deformation energy of battery packs changing with time obtained in simulation analyses.

FIG. 8 is a graph showing curves of plastic deformation energy of housings of the battery packs changing with time obtained in the simulation analyses.

FIG. 9 is a graph showing curves of plastic deformation energy of jellyrolls of battery cells in the battery packs changing with time obtained in the simulation analyses.

FIG. 10 is a graph showing curves of plastic deformation energy of casings of the battery cells in the battery packs changing with time obtained in the simulation analyses.

FIG. 11 is a schematic structural view of a battery pack according to yet another embodiment of the present disclosure.

### DETAILED DESCRIPTION

The present disclosure will now be described in detail with reference to the accompanying drawings and embodiments in order to make the objects, technical solutions, and advantages of the present disclosure more clear. It should be understood that the specific embodiments described herein are only for explaining the present disclosure, and not intended to limit the present disclosure.

In the description of the present disclosure, it is to be understood that terms such as “central”, “upper”, “lower”, “front”, “rear”, “left”, “right”, “vertical”, “horizontal”, “top”, “bottom”, “inner”, “outer”, should be construed to refer to the orientation as shown in the drawings. These relative terms are for convenience of description and do not require that the present disclosure be constructed or operated in a particular orientation.

In addition, terms such as “first” and “second” are used herein for purposes of description and are not intended to indicate or imply relative importance or significance or to imply the number of indicated technical features. Thus, features limited by “first” and “second” are intended to indicate or imply including one or more than one of these features. Further, in the description of the present disclosure, “a plurality of” means two or more than two, unless specified otherwise.

In the description of the present disclosure, it should be understood that, unless specified or limited otherwise, the terms “mounted”, “connected”, and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the particular embodiment of the present disclosure.

In the present disclosure, unless specified or limited otherwise, a structure in which a first feature is “on” or “below” a second feature can include an embodiment in which the first feature is in direct contact with the second feature, and can also include an embodiment in which the first feature and the second feature are not in direct contact with each other, but are connected via an additional feature disposed therebetween. Furthermore, a first feature “on”, “above”, or “on top of” a second feature may include an embodiment in which the first feature is right or obliquely “on”, “above”, or “on top of” the second feature, or just means that the first feature is at a height higher than that of the second feature; while a first feature “below”, “under”, or “on bottom of” a second feature may include an embodiment in which the first feature is right or obliquely “below”, “under”, or “on bottom of” the second feature, or just means that the first feature is at a height lower than that of the second feature.

It is to be understood that when an element is referred to as being “fixed” or “disposed” on another element, it can be directly on the other element or intervening elements may be present. When an element is referred to as being “connected” to another element, it can be directly connected to the other element or intervening elements may be present. The terms “vertical”, “horizontal”, “upper”, “lower”, “left”, and “right” and other similar expressions used herein is for the purpose of describing particular embodiments only and is not intended to be limiting of the present disclosure.

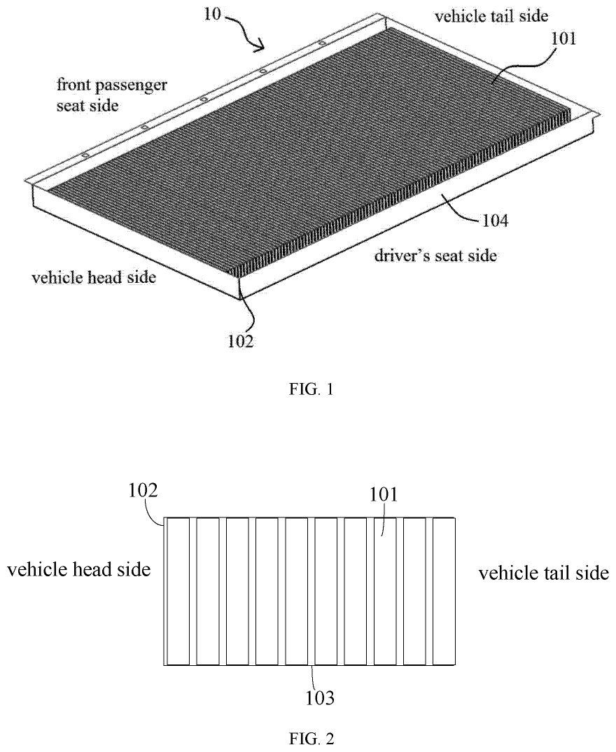

Referring to FIGS. 1 and 2, FIG. 1 is a schematic structural view of a battery pack 10 for an electric vehicle in related art, and FIG. 2 is a partially enlarged view, showing an arrangement of battery cells 101 in a housing 102 of the battery pack 10. In the battery pack 10 for the electric vehicle, in order to contain the battery cells 101 as many as possible in a single housing 102 and make the installation and the fixation of the battery cells 101 easy, the battery cells 101 are generally fixed in the housing 102 in a vertical arrangement manner. Specifically, the battery cells 101 are fixed to a bottom face 103 of the housing 102 and positioned in parallel with each other, and all of the battery cells 101 are perpendicular to the bottom face 103 and lateral faces 104 of the housing 102 of the battery pack 10. The bottom face 103 of the housing 102 of the battery pack 10 refers to a face of the housing 102 to be disposed adjacent to and facing a floor panel of the electronic vehicle. The lateral faces 104 of the housing 102 of the battery pack 10 refer to faces of the housing 102 located laterally with respect to the battery cells 101 and opposite to each other in a width direction of the electric vehicle. Specifically, the lateral faces 104 extend in a length direction of the electric vehicle, and the battery cells 101 are perpendicular to the lateral faces 204 and parallel to the width direction of the electric vehicle.

The inventors found that in the bottom collision accident, at the moment that an object such as a stone on the road collides with the floor panel of the electric vehicle in driving of the vehicle, an inertial force in the driving direction of the electric vehicle is exerted on the battery cells and causes the bending deformations of the battery cells in the driving direction of the electric vehicle. As the battery cells are fixed to the bottom face of the housing of the battery pack in the vertical arrangement manner, the bending deformations caused by the inertial force are concentrated at the positions adjacent to the fixing points of the battery cells, i.e., at local regions of the battery cells. When the concentrated deformation amount exceeds the deformation limit of the battery cells, the battery cells will undergo a short circuit and a thermal runway. In view of this, the present disclosure provides a new arrangement of the battery cells for the electric vehicle.

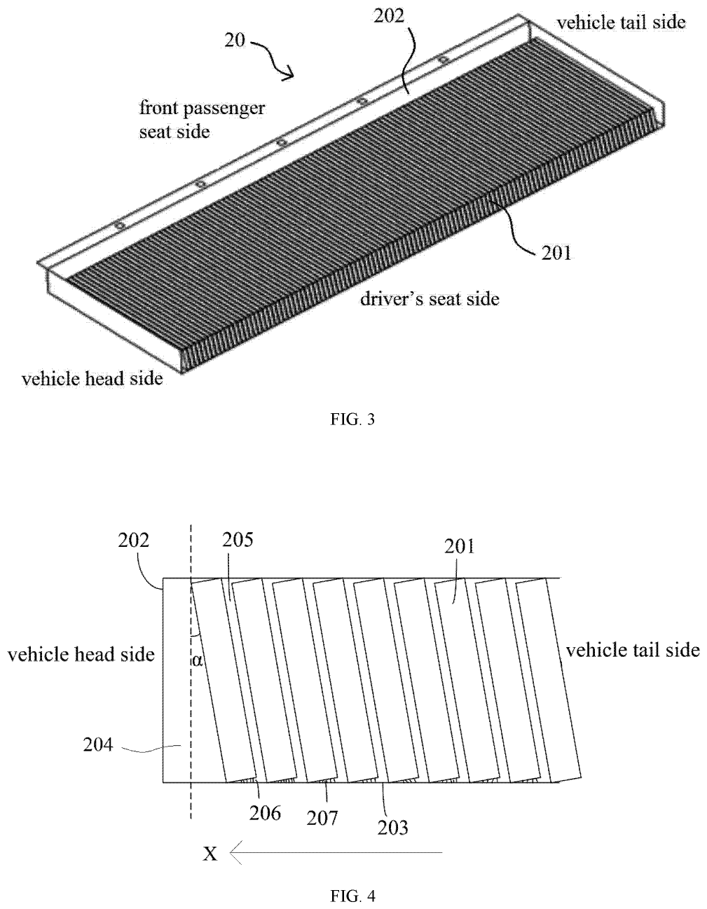

Referring to FIGS. 3 and 4, FIG. 3 is a schematic structural view of a battery pack 20 for the electric vehicle according to an embodiment of the present disclosure, and FIG. 4 is a partially enlarged view, showing the arrangement of battery cells 201 in a housing 202 of the battery pack 20. In the battery pack 20, the battery cells 201, for example, in a rectangular shape, are fixed in the housing 202 of the battery pack 20 in an inclined arrangement manner. Specifically, the housing 202 includes a bottom face 203 and two lateral faces 204. The bottom face 203 is disposed adjacent to and facing a floor panel of the electronic vehicle. The lateral faces 204 are located laterally with respect to the battery cells 201 and opposite to each other in a width direction of the electric vehicle. Specifically, the lateral faces 204 extend in a length direction of the electric vehicle, and the battery cells 201 are perpendicular to the lateral faces 204 and parallel to the width direction of the electric vehicle. The battery cells 201 are fixed to a bottom face 203 of the housing 202 and positioned in parallel to each other. Moreover, as contrast to the battery cells 101 perpendicular to the bottom face of the housing in the above-described related art, the battery cells 201 are inclined forward by an angle α in the driving direction X of the electric vehicle, i.e., the battery cells 201 are inclined toward the vehicle head side and the bottom face 203 by the angle α. Therefore, the angle α is formed between a line perpendicular to the bottom face 203 of the housing 202 and the battery cells 201. More specifically, a length direction of the rectangular battery cells 201 is parallel to the width direction of the electric vehicle and perpendicular to the lateral faces 204 of the housing 202. A width direction of the rectangular battery cells 201 is inclined with respect to the line perpendicular to the bottom face 203 of the housing 202. The angle α is formed between the width direction of the battery cells 201 and the line perpendicular to the bottom face 203 of the housing 202.

As compared to the vertical arrangement of the battery cells 101, the battery cells 201 in this embodiment are inclined forward in the driving direction X by the angle α, i.e., the battery cells are previously fixed at the bottom face 203 in an inclined state. In this way, at the moment that the object such as a stone on the road collides with the floor panel of the electric vehicle in driving, since the battery cells are previously arranged in the inclined state, the bending deformations of the battery cells caused by the inertial force can be effectively alleviated, the concentrated deformation amount can be reduced, and the concentrated deformation can be reduced or even eliminated, so that the deformation of the battery cells can be confined within the deformation limit thereof, thus avoiding the short circuit and the thermal runaway of the battery cells 201.

The forward inclination angle α of the battery cells 201 can be larger than 0° and smaller than or equal to 45°. In this range, the fixing stability of the battery cells 201 in the housing 202 of the battery pack 20 can be ensured while keeping the battery cells 201 inclined forward, and the decrease in the connecting and fixing stability between lower portions of the battery cells 201 and the bottom face 203 of the housing 202 of the battery pack 20, caused by an over large forward inclination angle α of the battery cells 201, can be avoided. Moreover, by preventing an over large forward inclination angle α of the battery cells 201, the occupied inner space of the housing 202 of the battery pack 20 can be reduced, and for example, a size of an inclination gap 206 between a bottom face of the battery cell 201 and the bottom face 203 of the housing 202 formed by the forward inclination of the battery cell 201 toward the bottom face 203 of the housing 202 in the driving direction X can be reduced, so that the quantity of the battery cells 201 contained in the housing 201 can be ensured, which in turn ensures the output power of the entire battery pack 20.

The forward inclination angle α of the battery cells 201 can be suitably adjusted according to the parameters of the battery cells 201 for different electric vehicle, such as the structure, the width, and the thickness of the battery cells 201, to ensure the fixing stability of the battery cells 201 in the housing 202 of the battery pack 20 and avoid the deformation of the battery cells 201 caused by long time inclination thereof.

Furthermore, in this embodiment, the battery cells 201 in the housing 202 of the battery pack 20 are kept parallel to each other while all of them are inclined forward. As such, the uniformity of the forward inclined battery cells 201 in the housing 202 of the battery pack 20 is improved, and the free space caused by the forward inclination of the battery cells 201 in the housing 202 is reduced, and more battery cells 201 can be contained in the housing 202 of the battery pack 20.

Furthermore, a deformation accommodating gap 205 can be formed between any two adjacent battery cells 201, e.g., between two adjacent parallel faces of the two adjacent battery cells 201, to accommodate the deformations of the battery cells 201.

In this way, it can be avoided that two adjacent battery cells 201 directly collide with each other caused by different deformations thereof as the impact energy in the bottom collision accident is gradually diffused in all directions from the collision point. The protection for the battery cells can be improved by reducing the secondary collision between the battery cells 201 in the bottom collision accident. The deformation accommodating gaps 205 can also be used as air flowing gaps, so that air can flow in the battery pack under normal conditions, and the utilization rate of the gaps 205 is increased. To form the deformation accommodating gaps 205, parallel and spaced grooves can be formed on the bottom face 103 of the housing 102 for respectively accommodating the battery cells 201. In another embodiment, spacers can be arranged between the battery cells 201 to define the deformation accommodating gaps 205.

Furthermore, in the forward inclined arrangement of the battery cells 201, a support 207 can be provided in the inclination gap 206 between the bottom face of the battery cell 201 and the bottom face 203 of the housing 202. The support 207 can be selected according to different designs and working conditions to achieve different effects.

For example, if the housing 202 of the battery pack 20 has the same structure as the housing of a conventional battery pack, i.e., the bottom face 203 of the housing 202 is planar, then rigid supports 207 can be provided in the inclination gaps 206 between the bottom faces of the battery cells 201 and the bottom face 203 of the housing 202. Moreover, a structural adhesive can be used to fixedly bond the supports 207 to the battery cells 201 and to the housing 202. In this way, the forward inclination angle α of the battery cells 201 can be accurately controlled. Furthermore, the housing of the battery pack in related art in which the battery cells are fixed in the vertical arrangement manner can be used as the housing 201 of the battery pack 20, so that the reconfiguration and the remanufacture of the housing of the battery pack can be saved and the manufacture cost of the entire battery pack 20 can be reduced.

Alternatively, the supports 207 to be provided in the inclination gaps 206 can be made of a compression-resistant buffer material, such as the expanded polypropylene (EPP) with a flame retardant. As such, not only the inclination gaps 206 can be effectively and quickly filled, but also the vibration resistance of the battery cells 201 can be improved due to the compression-resistance and the buffer performance of the supports 207, thus improving the stability in use and the service life of the entire battery pack 20.

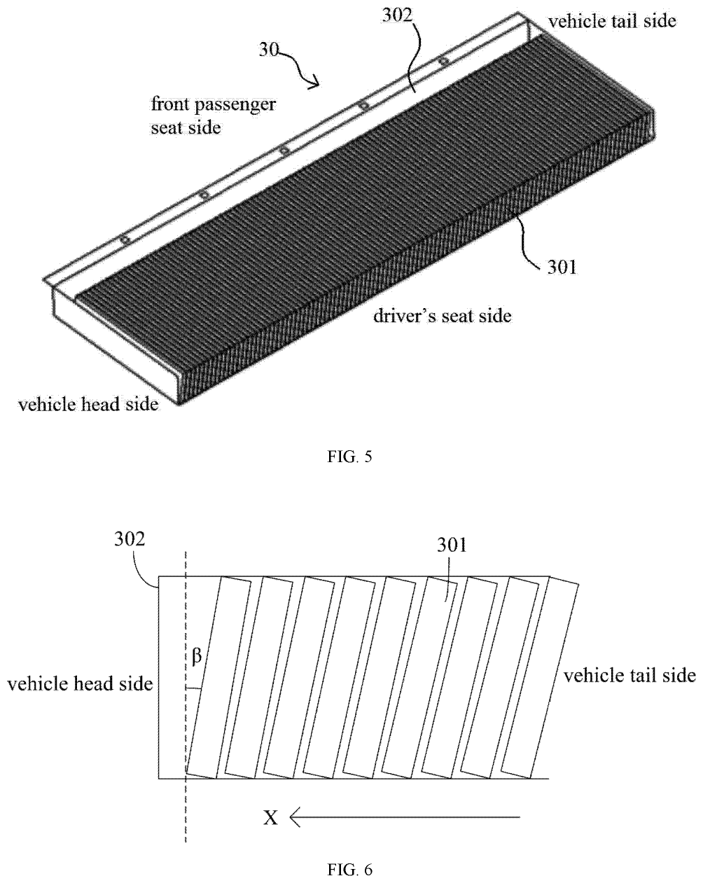

Referring to FIGS. 5 and 6, FIG. 5 is a schematic structural view of a battery pack 30 for the electric vehicle according to another embodiment of the present disclosure, and FIG. 6 is a partially enlarged view, showing the arrangement of battery cells 301 in a housing 302 of the battery pack 30. The battery pack 30 in this embodiment is substantially the same as the battery pack 20 in the above-described embodiment, except that the inclination direction of the battery cells 301 is different.

In the battery pack 30, the battery cells 301 are also fixed in the housing 302 of the battery pack 30 in the inclined arrangement manner. Specifically, the battery cells 301 are fixed to a bottom face 303 of the housing 302 and positioned in parallel to each other. Moreover, as contrast to the battery cells 101 perpendicular to the bottom face of the housing, the battery cells 201 are inclined backward by an angle β in the driving direction X of the electric vehicle, i.e., the battery cells 201 are inclined toward the vehicle tail and the bottom face 303 by the angle β. Therefore, the angle β is formed between a line perpendicular to the bottom face 203 of the housing 202 and the battery cells 201. More specifically, the angle β is formed between the width direction of the battery cells 301 and the line perpendicular to the bottom face 303 of the housing 302.

The backward inclination angle β of the battery cells 301 can be larger than 0° and smaller than or equal to 45°.

As contrast to the vertical arrangement of the battery cells 101, the battery cells 301 in this embodiment are inclined backward in the driving direction X by the angle β, i.e., the battery cells 301 are also fixed at the bottom face 303 in an inclined state. In this way, at the moment that the object such as a stone on the road collides with the floor panel of the electric vehicle in driving, since the battery cells are previously arranged in the inclined state, the bending deformations of the battery cells caused by the inertial force can be effectively alleviated, the concentrated deformation amount can be reduced, and the concentrated deformation can be reduced or even eliminated, so that the deformation of the battery cells can be confined within the deformation limit thereof, thus avoiding the short circuit and the thermal runaway of the battery cells.

Hereafter, at the moment of the collision, the energies consumed by plastic deformation of the bottoms of the battery packs 20 and 30 in the above two embodiments and the bottom of the battery pack 10 in related art are compared through simulation analyses, to verify the collision safety performances of the battery packs 20 and 30 in the bottom collision accident. The energy consumed by the plastic deformation of an article is also called the plastic deformation energy of the article, referring to the energy to be absorbed by the article to cause the plastic deformation thereof.

In the simulation analyses, the impact on the bottoms of the battery packs is along the forward driving direction X of the electric vehicle, and the battery packs 10, 20, and 30 have substantially the same structure except that the battery cells 101 in the battery pack 10 are in the vertical arrangement, the battery cells 201 in the battery pack 20 are in the forward inclined arrangement, and the battery cells 301 in the battery pack 30 are in the backward inclined arrangement. The inclined arrangements with the forward inclination angle α of 10°, 20°, and 30° for the battery pack 20 and the inclined arrangements with the backward inclination angle β of 10°, 20°, and 30° for the battery pack 30 are analyzed. The total plastic deformation energies of the battery backs 10, 20, 30, the plastic deformation energies of the housings 102, 202, 302 of the battery packs 10, 20, 30, the plastic deformation energies of jellyrolls of the battery cells 101, 201, 301 in the battery packs, and the plastic deformation energies of the casings of the battery cells 101, 201, 301 in the battery packs are compared. Therefore, the collision safety performances of the battery packs 20 and 30 in the bottom collision accident are multi-dimensionally verified.

If the total plastic deformation energy of the battery pack is relatively low, which means that the energy absorbed by the entire battery pack in the bottom collision is relatively low, then the possibility of the thermal runaway of the entire battery back is relatively low. If the plastic deformation energy of the housing of battery pack is relatively high, which means that the energy absorbed by the housing of the battery back in the bottom collision is relatively high and the structural energy absorption effect of the housing of the battery pack is relatively good, then the possibility of the thermal runaway of battery cells in the housing of the battery pack is reduced. If the plastic deformation energy of the jellyroll of the battery cell in the battery pack is relatively low, which means that the energy absorbed by the jellyroll of the battery cell in the bottom collision is relatively low, then the possibility of the thermal runaway of the battery cell is relatively low. If the plastic deformation energy of the casing of the battery cell in the battery pack is relatively low, which means the energy adsorbed by the casing of the battery cell in the bottom collision is relatively low, then the possibility of the thermal runaway of the battery cell is relatively low.

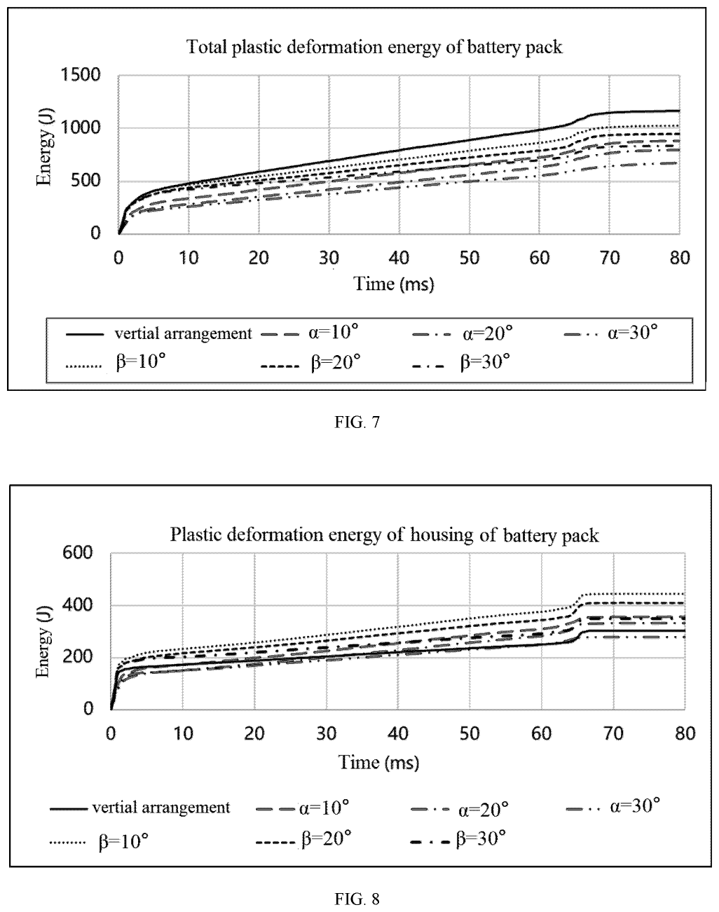

Graphs comparing curves of the plastic deformation energy with time obtained in the simulation analyses are shown in FIGS. 7 to 10, and the energy absorption proportions (EAP) of different components in the battery packs with different arrangements of the battery cells obtained in the simulation analyses are list in Table 1.

TABLE 1

| | | Forward | Forward | Forward | Backward | Backward | Backward |
|---|---|---|---|---|---|---|---|
| | | inclination | inclination | inclination | inclination | inclination | inclination |
| | Vertical | with angle | with angle | with angle | with angle | with angle | with angle |
| | arrangement | of 10° | of 20° | of 30° | of 10° | of 20° | of 30° |
| EAP of | 26.0 | 40.8 | 41.8 | 41.4 | 43.3 | 43.2 | 42 |
| housing of | | | | | | | |
| battery pack | | | | | | | |
| (%) | | | | | | | |
| EAP of | 44.2 | 37.9 | 37.6 | 42.7 | 35.6 | 35.7 | 43.1 |
| jellyroll of | | | | | | | |
| battery cell | | | | | | | |
| (%) | | | | | | | |
| EAP of | 21.6 | 10.7 | 15.4 | 11.2 | 9.6 | 16.1 | 10.5 |
| casing of | | | | | | | |
| battery cell | | | | | | | |
| (%) | | | | | | | |

Referring to FIG. 7, FIG. 7 is a graph comparing curves of the total plastic deformation energy of the battery packs changing with time obtained in the simulation analyses. It can be seen that in the bottom impact process, the total plastic deformation energies of the battery packs 20 with different inclination angles of the battery cells 201 and the battery packs 30 with different inclination angles of the battery cells 301 are lower than the total plastic deformation energy of the battery pack 10. This result suggests that as compared to the vertical arrangement of the battery cells, the inclined arrangement of the battery cells can effectively decrease the total plastic deformation energy of the battery pack in the bottom collision and thus reduce the risk of the thermal runaway of the battery pack caused by the bottom collision.

Referring to FIG. 8, FIG. 8 is a graph comparing curves of the plastic deformation energy of the housings of the battery packs changing with time obtained in the simulation analyses. It can be seen that in the bottom collision, the plastic deformation energies of the housings of the battery packs 20 with different inclination angles of the battery cells 201 and the battery packs 30 with different inclination angles of the battery cells 301 are generally higher than the plastic deformation energy of the housing of the battery pack 10. This result suggests that as compared to the vertical arrangement of the battery cells, the inclined arrangement of the battery cells can effectively increase the structural energy absorption of the housing of the battery pack, reduce the risk of the thermal runaway of the battery cells in the housings, and thus reduce the risk of the thermal runaway of the battery pack after the bottom collision.

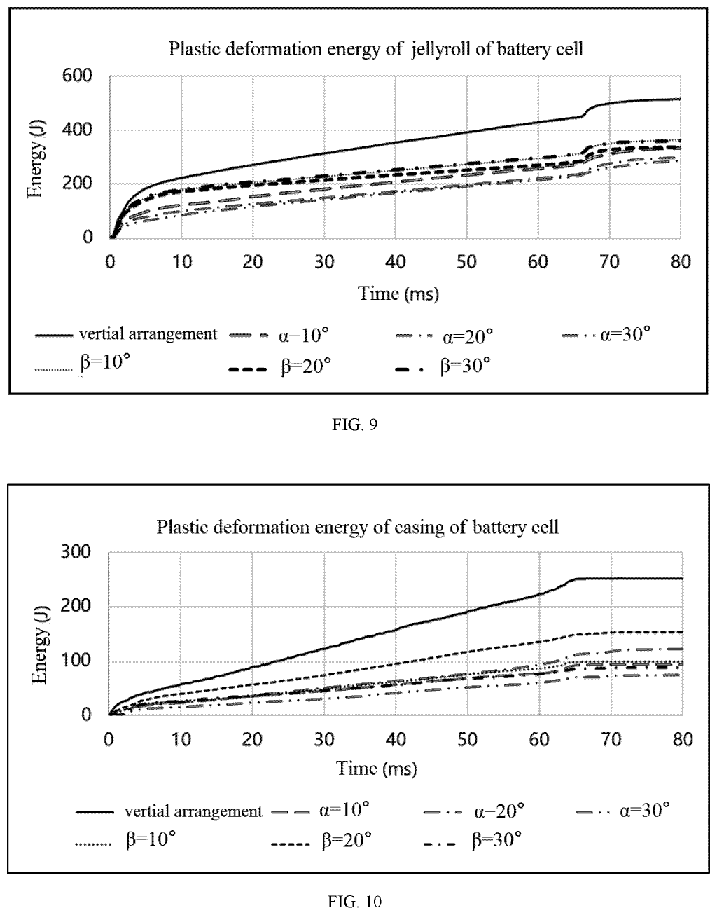

Referring to FIG. 9, FIG. 9 is a graph comparing curves of the plastic deformation energy of the jellyrolls of battery cells in the battery packs changing with time obtained in the simulation analyses. It can be seen that in the bottom collision, the plastic deformation energies of the jellyrolls of the battery cells in the battery packs 20 with different inclination angles of the battery cells 201 and the battery packs 30 with different inclination angles of the battery cells 301 are significantly lower than the plastic deformation energy of the jellyroll of the battery cell 101 in the battery pack 10. This result suggests that as compared to the vertical arrangement of the battery cells, the inclined arrangement of the battery cells can significantly decrease the plastic deformation energy of the jellyroll of the battery cell in the battery pack in the bottom collision and thus reduce the risk of the thermal runaway of the battery cell after the bottom collision.

Referring to FIG. 10, FIG. 10 is a graph comparing curves of the plastic deformation energy of the casings of battery cells in the battery packs changing with time obtained in the simulation analyses. It can be seen that in the bottom collision, the plastic deformation energies of the casings of the battery cells in the battery packs 20 with different inclination angles of the battery cells 201 and the battery packs 30 with different inclination angles of the battery cells 301 are significantly lower than the plastic deformation energy of the casing of the battery cell in the battery pack 10. This result suggests that as compared to the vertical arrangement of the battery cells, the inclined arrangement of the battery cells can significantly decrease the plastic deformation energy of the casing of the battery cell in the battery pack in the bottom collision and thus reduce the risk of the thermal runaway of the battery cell after the bottom collision.

Moreover, from the data of energy absorption proportions of different components of the different battery packs in the impact and collision obtained in the simulation analyses in Table 1, it can be seen that as compared to the vertical arrangement of the battery cells 101 in the battery pack 10, the inclined arrangement of the battery cells 201, 301 in the battery pack 20, 30 in the present disclosure can effectively change the energy absorption proportions of the housing of the battery pack, the jellyroll of the battery cell, and the casing of the battery cell in the impact and collision process.

Specifically, the energy absorption proportion of the housing of the battery pack with the battery cells in the vertical arrangement is 26.0%, while the energy absorption proportion of the housing of the battery pack with the battery cells in the inclined arrangement is above 40%, which suggests that more impact energy can be absorbed by the housing of the battery pack in the bottom collision accident due to the inclined arrangement of the battery cells, so that less energy is transmitted to the battery cells.

Furthermore, the energy absorption proportion of the jellyroll of the battery cell in the battery pack with the battery cells in the vertical arrangement is 44.2%, while the energy absorption proportion of the jellyroll of the battery cell in the battery pack with the battery cells in the inclined arrangement is decreased to 35.6% to the great extent, which suggests that the impact energy absorbed by the jellyroll of the battery cell in the bottom collision accident can be decreased due to the inclined arrangement of the battery cells.

Furthermore, the energy absorption proportion of the casing of the battery cell in the battery pack with the battery cells in the vertical arrangement is 21.6%, while the energy absorption proportion of the casing of the battery cell in the battery pack with the battery cells in the inclined arrangement is decreased to about 15% and to 9.6% to the great extent, which suggests that the impact energy absorbed by the casing of the battery cell in the bottom collision accident can be significantly decreased due to the inclined arrangement of the battery cells.

In view of the above, it can be seen that in the same housing of the battery pack, by changing the arrangement manner of the battery cells from the vertical arrangement to the inclined arrangement without changing the battery cells and the floor panel, the bending deformation of the battery cells caused by the inertial force at the moment that the object such as a stone on the road collides with the floor panel of the electric vehicle in the driving process can be reduced, and the deformation amount of the battery cell at the position where the deformations are concentrated can also be reduced. Moreover, more impact energy is transferred from the battery cells to the housing of the battery pack and absorbed by the housing of the battery pack. As a result, the risks of the short circuit and the thermal runaway of the battery cells in the bottom collision are reduced, and the safety and the reliability of the entire battery pack in the bottom collision accident are increased.

Furthermore, from FIGS. 7 to 10, it can be seen that in the arrangement that the battery cells are inclined toward the same direction, the battery cells exhibit different plastic deformation performances in the bottom collision accident when the inclination angle thereof is varied. Therefore, in some embodiments, the inclination angle of the battery cells can be adjusted to achieve different performance of the entire battery pack in the bottom collision accident. In some embodiments, the battery cells in the same battery pack can take different inclination angles according to the positions of the battery cells, that is, the battery cells with different inclination manners and/or inclination angles can be provided in the same battery pack.

Furthermore, from FIGS. 7 to 10, it can be seen that in the bottom collision accident where the impact is along the driving direction X of the electric vehicle, as compared to the backward inclined arrangement of the battery cells, the forward inclined arrangement of the battery cells can achieve better plastic deformation energy performance, including the lower total plastic deformation energy of the battery pack, the higher plastic deformation energy of the housing of the battery pack, the lower plastic deformation energy of the jellyroll of the battery cell in the battery pack, and the lower plastic deformation energy of the casing of the battery cell in the battery pack.

Based on this, in another embodiment of the present disclosure, the battery cells in the housing of the battery pack are inclined by different angles. Specifically, the battery cells adjacent to the vehicle head side are inclined forward in the driving direction of the electric vehicle, while the battery cells adjacent to the vehicle tail side are inclined backward in the driving direction of the electric vehicle.

In this way, in the forward driving process of the electric vehicle, when the object collides with the electric vehicle from the vehicle head side, the impact on the bottom of the battery pack can be better absorbed by the portion of the housing of the battery pack adjacent to the vehicle head side and the forward inclined battery cells. On the contrary, in the backward driving process of the electric vehicle, when the object collides with the electric vehicle from the vehicle tail side, the impact on the bottom of the battery pack can be better absorbed by the portion of the housing of the battery pack adjacent to the vehicle tail side and the backward inclined battery cells. In the backward driving process of the electric vehicle, the battery cells inclined backward with respect to the vehicle head in fact are in the forward inclined state with respect to the vehicle tail, thereby having better plastic deformation energy performance, and thus increasing the safety and the reliability of the battery pack in the bottom collision accident in the backward driving process of the electric vehicle.

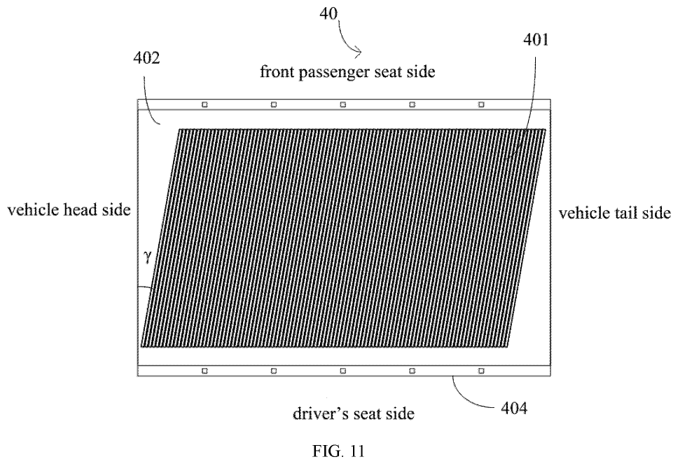

Referring to FIG. 11, FIG. 11 is a schematic structural view of a battery pack 40 for the electric vehicle according to yet another embodiment of the present disclosure. In the battery pack 40, battery cells 401 are fixed in a housing 402 of the battery pack 40 in a laterally inclined arrangement manner. More specifically, the battery cells 401 are fixed to a bottom face 403 of the housing 402 and positioned in parallel with each other. Moreover, as compared to the battery cells 101 whose length direction is perpendicular to the lateral faces of the housing, the length direction of the battery cells 101 is inclined with respect to the lateral faces 404 of the housing 402. The ends of the battery cells 401 at one side (e.g., at the front passenger seat side) is rotated about ends of the battery cells 401 at the opposite side (e.g., the driver's seat side) toward the vehicle tail side, so that a lateral inclination angle γ is formed between the battery cells 401 and a line perpendicular to the lateral faces 404 of the housing 402. More specifically, the lateral inclination angle γ larger than zero is formed between the length direction of the battery cells 201 and the line perpendicular to the lateral faces 404 of the housing 202.

By analyzing the inertial force exerted on the battery cells in the driving direction X at the moment that the floor panel of the electric vehicle collides with the object in the driving process of the electric vehicle, it is found that the battery cells may not only be bended forward with respect to the bottom face of the housing, but also be bended laterally with respect to the lateral faces of the housing due to the inertial force, especially when the impact point on the floor panel is adjacent to one of the lateral faces of the housing. The closer the impact point to a lateral face of the housing, the larger the laterally bending extent, and the severer the deformation concentration phenomenon.

In view of this, by having the battery cells laterally inclined, the extent of the lateral bending deformation of the battery cells due to the inertial force can be decreased, the concentrated lateral deformation amount can be reduced, and the concentration of the lateral deformation can be reduced or even eliminated, so that the deformation of the battery cells can be confined within the deformation limit thereof, the short circuit and thermal runaway of the battery cells can be avoided, and the safety and the reliability of the entire battery pack in the bottom collision accident can be improved.

Furthermore, in another embodiment of the present disclosure, the battery cells are fixed in the housing of the battery pack in a complex inclined arrangement manner. More specifically, the battery cells are positioned non-particular to either the bottom face or the lateral faces of the housing of the battery pack. The forward/backward inclination angle α/β is formed between the battery cells and the line perpendicular to the bottom face of the housing of the battery pack, while the lateral inclination angle γ is formed between the battery cells and the line perpendicular to the lateral faces of the housing of the battery pack. The forward/backward inclination angle α/β and the lateral inclination angle γ are both larger than zero.

When the battery cells are fixed in the housing of the battery pack in the complex inclined arrangement manner, at the moment that the object such as a stone on the road collides with the floor panel of the electric vehicle in driving, since the battery cells are previously arranged in the complex inclined state, the bending deformations of the battery cells in different directions caused by the inertial force can be effectively alleviated, and the concentrated deformation amount for the entire battery cell can be reduced, so that the deformation of the battery cells can be confined within the deformation limit thereof, thus avoiding the short circuit and the thermal runaway of the battery cells and improving the safety and the reliability of the entire battery pack in the bottom collision accident.

The inclination angle of the battery cells toward the bottom face of the housing of the battery pack and the inclination direction and angle of the battery cells toward lateral faces of the housing of the battery pack can be adjusted according to different electric vehicles, for example, heights of the floor panels of different electric vehicles or operating conditions of different electric vehicles, to achieve the optimized safety and reliability of the battery pack in the bottom collision accident.

Furthermore, the battery cells in the above-described embodiments are in the shape of rectangle. However, other shapes can be adopted in some embodiments according to the design requirements of the battery pack. For example, cylindrical battery cells can be fixed in the housing of the battery pack in the inclined arrangement manner to reduce the damage to the battery cells in the bottom collision accident and improve the safety and the reliability of the entire battery pack without increasing the cost and the overall weight of the electric vehicle.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. An arrangement of battery cells in a battery pack for an electric vehicle, wherein the battery cells are fixed in a housing of the battery pack and inclined with respect to a bottom face and/or a lateral face of the housing of the battery pack.

2. The arrangement of claim 1, the battery cells are inclined toward a vehicle head side of the electric vehicle.

3. The arrangement of claim 1, the battery cells are inclined toward a vehicle tail side of the electric vehicle.

4. The arrangement of claim 1, wherein an angle between the battery cells and the bottom face and/or the lateral face of the housing of the battery pack is larger than or equal to 45° and smaller than 90°.

5. The arrangement of claim 1, wherein an inclination gap is defined between a bottom face of the battery cell and the bottom face of the housing of the battery pack, and a support is disposed in the inclination gap.

6. The arrangement of claim 5, wherein the support is made of a compression-resistant buffer material.

7. The arrangement of claim 1, wherein all of the battery cells in the battery pack are inclined in the same direction.

8. The arrangement of claim 7, wherein all of the battery cells in the battery pack are positioned in parallel with each other.

9. The arrangement of claim 7, wherein a deformation accommodating gap is formed between any two adjacent battery cells.

10. The arrangement of claim 1, wherein a number of the battery cells adjacent to a vehicle head side of the electric vehicle are inclined toward the vehicle head side of the electric vehicle, and a number of the battery cells adjacent to a vehicle tail side of the electrical vehicle are inclined toward the vehicle tail side of the electric vehicle.

11. A battery pack for an electric vehicle, the battery pack comprising a housing and battery cells fixed in the housing, wherein the battery cells are inclined with respect to a bottom face and/or a lateral face of the housing of the battery pack.

12. The battery pack of claim 11, wherein the battery cells are inclined toward a vehicle head side of the electric vehicle.

13. The battery pack of claim 11, wherein the battery cells are inclined toward a vehicle tail side of the electric vehicle.

14. The battery pack of claim 11, wherein an angle between the battery cells and the bottom face and/or the lateral face of the housing of the battery pack is larger than or equal to 45° and smaller than 90°.

15. The battery pack of claim 11, wherein an inclination gap is defined between a bottom face of the battery cell and the bottom face of the housing of the battery pack, and a support is disposed in the inclination gap.

16. The battery pack of claim 15, wherein the support is made of a compression-resistant buffer material.

17. The battery pack of claim 11, wherein all of the battery cells in the battery pack are inclined in the same direction.

18. The battery pack of claim 17, wherein all of the battery cells in the battery pack are positioned in parallel with each other.

19. The battery pack of claim 17, wherein a deformation accommodating gap is formed between any two adjacent battery cells.

20. The battery pack of claim 11, wherein a number of the battery cells adjacent to a vehicle head side of the electric vehicle are inclined toward the vehicle head side of the electric vehicle, and a number of the battery cells adjacent to a vehicle tail side of the electrical vehicle are inclined toward the vehicle tail side of the electric vehicle.
